(19) United States
(12) Patent Application Publication
(10) Pub. No.: US 2021/0081071 A1
(43) Pub. Date: Mar. 18, 2021

(54) DISPLAY UNIBODY TO IMPROVE OPTICS

(71) Applicant: Dell Products L.P., Round Rock, TX (US)

(72) Inventors: Boon Heng Koh, Singapore (SG); Tuck Leong Lim, Singapore (SG); Surendran Ramachanthiran, Singapore (SG)

(73) Assignee: Dell Products L.P., Round Rock, TX (US)

(21) Appl. No.: 16/574,724

(22) Filed: Sep. 18, 2019

(51) Int. Cl. G06F 3/041; G06F 3/044; G02F 1/1333

(52) U.S. Cl. CPC G06F 3/0418; G06F 3/0412; G02F 2001/133331; G02F 1/133308; G02F 1/13338; G06F 3/044

(57) ABSTRACT

An information handling system display holds a cover glass with a minimal gap over a display panel, such as less than 4 mm, by assembly of the cover glass over the display panel through a shared unibody structure as an initial manufacture step. For instance, the display panel couples to the cover glass to create a unibody and then an adhesive tape couples this unibody to a support surface of the unibody structure that holds this unibody by the gap distance from the display panel.

### BACKGROUND OF THE INVENTION

### Field of the Invention

The present invention relates in general to the field of information handling system displays, and more particularly to an information handling system display having a unibody to improve optics.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Generally, information handling systems present processing output to end users as visual images at a display. Displays come in a variety of sizes and generate visual images with a variety of materials. Typically end users prefer flat panel displays that use liquid crystal or organic light emitting diode (OLED) pixels to generate visual images based upon pixel values provided by an information handling system. These pixels are built into a flat panel as an array typically compliant with a display standard, such as the High Definition (HD) and Ultra High Definition (UHD) display standards. A graphics controller defines an array of pixel values that are transferred to the flat panel display by a cable or wireless interface, such as a DisplayPort or HDMI cable. A timing controller in the display scans the pixel values to the array of pixels to generate the visual image. In addition, flat panel displays often include touch detection to accept touch inputs by an end user at the display surface. For instance, a capacitive touch detection sensor integrates with the flat panel display so that touch positions are detected by a touch controller and reported to an operating system. The operating system supports touch inputs at the display by associating detected touch positions with user interface presentations made at the display.

Generally, end users prefer larger display surfaces for presentation of visual information. A larger display surface can simultaneously present multiple pages of a document or multiple application windows having multiple documents. As display peripherals grow larger in the display area, they also tend to become heavier and more awkward to move. Thus, display peripherals with larger display areas tend to have more heavy duty chassis. Typically, the display itself mounts on a stand with an adjustable bracket so that the end user can view the display from a variety of angles, such as where an end user has multiple displays arranged around a desktop. In some situations, the display may have a forward-leaning or rear leaning orientation to adapt to different end user viewing heights. Many large displays, such as for use as large screen televisions, are mounted on walls, mobile carts or floor stands to provide better support and stability for end users.

As the display viewing area increases, difficulty tends to arise in addressing image viewing interference introduced by the Newton Ring phenomena, which tend to interfere with image presentation at touch enabled displays that include a cover glass. A Newton Ring is a circular dark and light interference pattern created by the reflection of light between two surfaces having a spherical surface relationship that creates different thicknesses of air between the reflecting surfaces. A constructive interference is created where light reflects in phase due to a path length difference of an odd multiple of the light wavelength divided by two. A destructive interference is created where light reflects 180 degrees out of phase due to a path length difference of an even multiple of the light wavelength divided by two. Constructive interference generates a bright fringe circular appearance while destructive interference generates a dark fringe circular appearance. Newton Rings may show up, for instance, where a large touch display panel cell warps toward the inner surface of the cover glass relative to a display when leaned forward.

One way to prevent Newton Rings is to adhere a display cover glass to the display panel surface with an optical bond solution, such as a silicon bonding solution, that eliminates the airgap between a cover glass and display panel surface, although the use of such adhesives tends to increase cost. Another solution is to coat the display glass with an anti-Newton Ring solution, however, the solution can scratch the glass surface if the airgap is too small with respect to the display diagonal size. A more common solution is to space the cover glass away from the display panel surface by a distance sufficient to overcome the Newton Ring phenomena. The distance for any particular display varies based upon display area, however, a gap of four millimeters or more between the display glass and display panel surface is not uncommon. Although such a gap reduces manufacture cost relative to other alternatives, it also increases the thickness of the display and introduces optical effects that impact the end user experience. For instance, the gap introduces a parallax error caused by refraction that makes touch location detection for a displayed user interface more difficult by creating an optical offset from the actual position.

### SUMMARY OF THE INVENTION

Therefore, a need has arisen for a system and method which holds a display cover glass and display panel surface in a narrow, spaced relationship without contact and without inducing Newton Rings.

In accordance with the present invention, a system and method are provided which substantially reduce the disadvantages and problems associated with previous methods and systems for holding a display cover glass and display panel surface in a spaced relationship that minimizes Newton Ring effects. A display panel and cover glass are held in a spaced relationship by a shared structure so that instances of spherical spaced relationship are minimized or avoided even where the gap between the cover glass and display panel is minimized.

More specifically, an information handling system display presents visual images based upon information provided from an information handling system, such as pixel values communicated from a graphics processor. The display has a display panel that integrates an array of pixels for presenting the visual image and a touch detection sensor, such as an infrared (IR) touch detection sensor. The display panel is held in a spaced relationship relative to a cover glass to provide a gap between the display panel and cover glass that prevents or otherwise minimizes introduction of a spherical relationship associated with generation of Newton Ring effects. For instance, a chassis structure couples to both the cover glass and the display panel in a fixed manner that promotes synchronous movement of the cover glass and display panel in response to vibration so that a spherical spaced relationship between the cover glass and display panel is avoided across the display viewing area. The chassis structure, display panel and cover glass are adhered, such as with adhesive tape and then assembled with a display housing to form a unibody structure. By avoiding relative movement between the display panel and cover glass that is associated with Newton Ring and panel scratch effects, a reduced gap size is supported, such as a gap that is a fraction of the thickness of the cover glass. In one example embodiment, the display panel and cover glass fixedly couple to each other with an adhesive tape by positioning the cover glass on a jig, removing the cover glass, positioning the display panel on the jig relative to the cover glass position, applying the adhesive tape to a chassis structure that holds the display panel, placing the cover glass on the jig at its position, and curing the adhesive tape with the display panel and cover glass coupled to the chassis structure. The display panel, cover glass and chassis structure are then assembled with a display housing to form a robust unibody structure.

The present invention provides a number of important technical advantages. One example of an important technical advantage is that a peripheral display has a cover glass coupled in a unibody frame relationship that maintains a spaced relationship while avoiding spherical spacing associated with generation of Newton Rings at the display. Decreased gap size between the display cover glass and display panel surface reduces parallax errors and the perceived depth illusions sometimes associated with increased gap sizes. A thinner display housing is manufactured with the decreased gap size and encased within a robust extrusion part for a slim final product. The cover glass and display panel surface are retained in a unibody structure to flex in a synchronized manner that reduces the creation of spherical spaced relationships associated with generation of Newton Rings and incidental contact that may result in scratching of the cover glass and/or display panel surface.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an example embodiment of an information handling system interfaced with a peripheral display;

FIG. 2 depicts a perspective exploded view of a display assembly unibody structure that supports a cover glass disposed over a display panel with a defined gap;

FIG. 3 depicts a cross sectional view of an example embodiment of a display having a minimized air gap supported by affixing a display panel and cover glass to a common chassis structure;

FIGS. 4A-4B depicts a side perspective table view of a jig table that aligns a board assembly cell and cover glass for assembly;

FIG. 5 depicts a flow diagram of a process for assembly of a display having a unibody structure; and

FIGS. 6A-6B depicts a flow diagram of a process for aligning the display panel and cover glass.

### DETAILED DESCRIPTION

An information handling system display manages Newton Ring effects with a reduced gap size between a display panel and cover glass by coupling the display panel and cover glass to a chassis structure that promotes synchronous movement of the display panel and cover glass in response to vibration or other forces. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

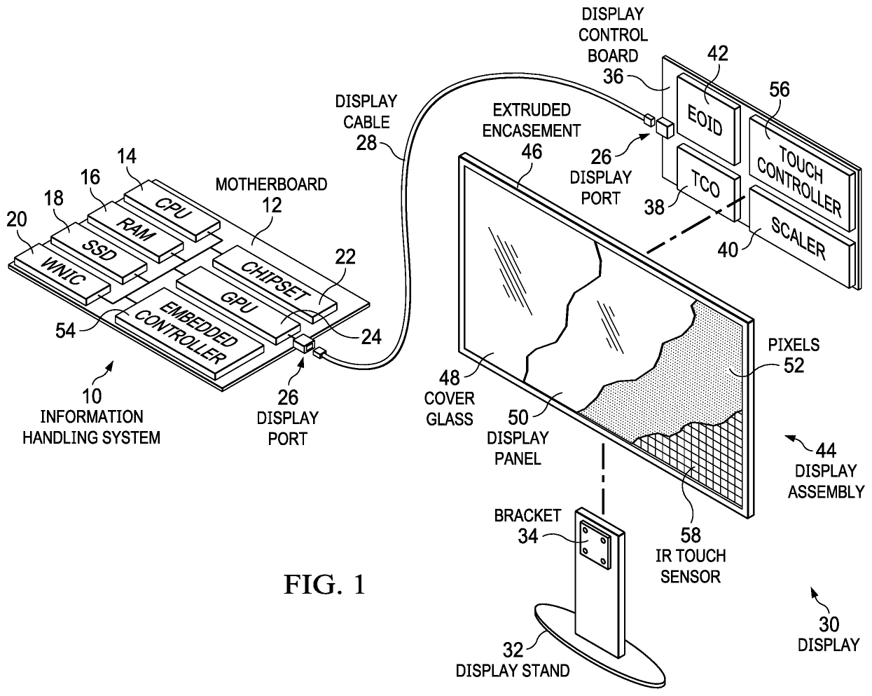

Referring now to FIG. 1, an example embodiment depicts an information handling system 10 interfaced with a peripheral display 30. In the example embodiment, information handling system 10 has a desktop configuration that is physically separate from display 30, although alternative embodiments may integrate information handling system 10 and display 30 in a common housing, such as with an all-in-one, convertible, tablet and/or multimedia configuration. Information handling system 10 processes information with processing components that communicate through a motherboard 12. A central processing unit (CPU) 14 executes instructions to process information in cooperation with a random access memory (RAM) 16. For instance, CPU 14 retrieves an operating system and applications from persistent memory of a solid state drive (SSD) 18 to RAM 16 for execution to generate visual information for presentation to an end user at display 30. The visual information is managed by a chipset 22 for further processing at a graphics processor unit (GPU) 24 to define visual images as an array of pixel values. The pixel values are then communicated to display 30 through a communication interface, such as a wireless network interface card (WNIC) 20 or display port 26 and display cable 28.

Display 30 has a display stand 32 that holds a display assembly 44 in an elevated viewing position, such as by coupling to a bracket 34, such as a VESA standard compliant bracket, which pivots about display stand 32 to adjust the end user viewing angle. A display control board 36 couples to the backside of display assembly 44 to provide communication of pixel values received from display port 26 for presentation at pixels 52. For instance, a timing controller (TCO) 38 receives the pixel values and scans the pixel values to individual pixels to create the visual image. A scalar 40 scales pixel values to different resolutions supported by display 30. An EDID stores display configuration information. A touch controller 56 applies position values of touches detected at a IR touch sensor 58 integrated in display 30 and communicates the touch locations to information handling system 10 as touch inputs. For example, touches are communicated to an embedded controller 54, which manages inputs received from input devices, and then to CPU 14 as inputs to an operating system or application associated with presented visual images.

Visual images are presented by a display panel 50 integrated in display assembly 44 by communication of pixel values to pixels 52. In the example embodiment, pixels 52 are liquid crystal pixels that present colors by filtering light passing through each pixel 52 from a backlight disposed behind display panel 50. In alternative embodiments, pixels 52 may be alternative types, such as organic light emitting diode (OLED) material. Display panel 50 is held in place by an extruded encasement that fits around a cover glass 48 coupled over top of display panel 50. Cover glass 48 provides protection for display panel 50 and integrated IR touch sensor 58 with a gap formed between the inner surface of cover glass 48 and the upper surface of display panel 50. Cover glass 48 is, for example, a treated glass surface to have enhanced hardness and resistance to breakage unless subject to high point impact force, such as Gorilla Glass or Heat Tempered Glass. Within display assembly 44, as is described in greater detail below, a chassis structure is provided to which both cover glass 48 and display panel 50 affix so that a defined gap is maintained between cover glass 48 and display panel 50. By maintaining a constant gap size, Newton Ring effects are suppressed, and the size of the gap may be decreased, resulting in a thinner display assembly 44.

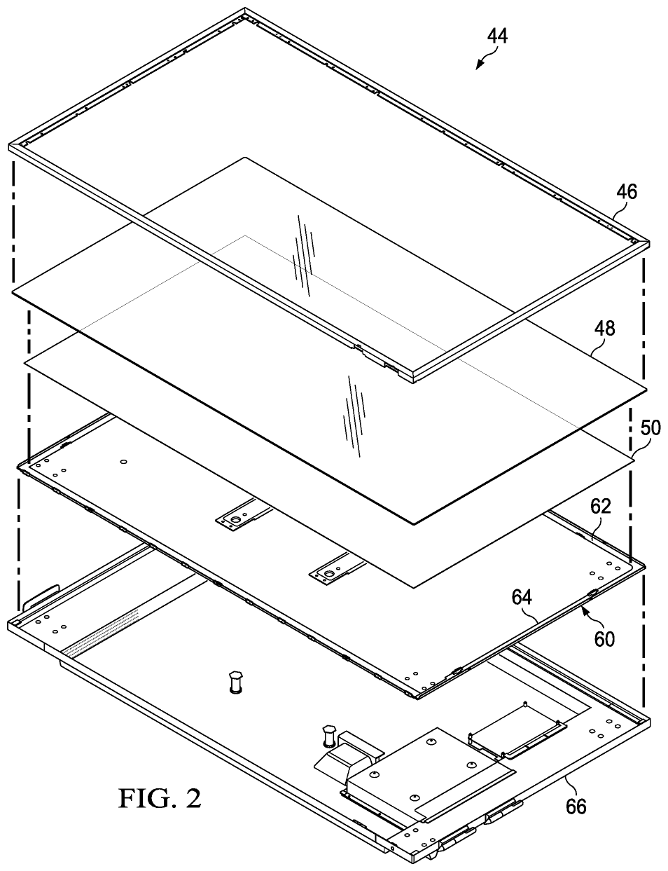

Referring now to FIG. 2, a perspective exploded view depicts display assembly 44 chassis structure 60 that supports cover glass 48 disposed over display panel 50 with a defined gap. In the example embodiment, assembly is accomplished by first coupling display panel 50 to cover glass 48 and chassis structure 60 at an inner circumference 64 to form what is referred to as a liquid crystal module by board assembly cell or “open cell” assembly approach. After the cover glass 48 couples with adhesive to display panel 50 within chassis structure 60, a unibody structure is created by assembly into the remaining display housing components. A support surface 62 is defined outside of inner circumference 64 of chassis structure 60 to have a raised support surface above the top surface of display panel 50 once coupled to inner circumference 64. Adhesive, such as an adhesive tape, is disposed on support surface 62 so that cover glass 48 couples to it with a gap formed between cover glass 48 and display panel 50. By sharing a common chassis structure 60, display panel 50 and cover glass 48 tend to move synchronously in response to vibration, resulting in a constant distance and suppression of any relative spherical relationships that may be associated with creation of Newton Ring effects. After cover glass 48 couples to chassis structure 60, extruded encasement 46 couples over cover glass 48 and to rear housing 66 to enclose display assembly 44. Affixing both cover glass 48 and display panel 50 to a common chassis structure 60 aids a common motion response while other elements of display assembly 44 may move more independently due to a lack of a common structure. The result of the chassis structure 60 providing a common structure for coupling cover glass 48 and display panel 50 is a damping effect that synchronizes motion of cover glass 48 and display panel 50 that is introduced by other parts of the display to which chassis structure 60 couples or otherwise receives vibration or motion forces.

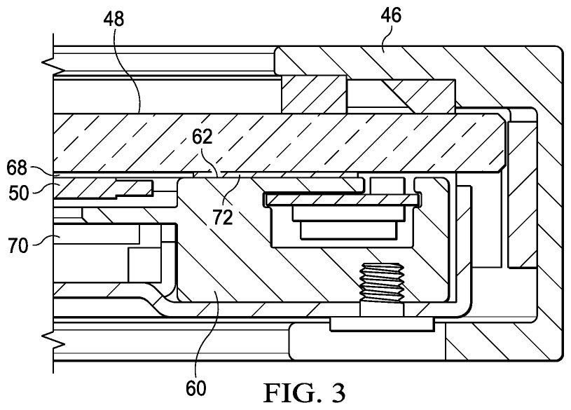

Referring now to FIG. 3, a side cross sectional view depicts an example embodiment of a display having a minimized air gap 68 supported by affixing display panel 50 and cover glass 48 to a common chassis structure 60. In the example embodiment, an extruded encasement 46 couples around chassis structure 60 without affixing to either cover glass 48 or display panel 50 so that vibrations and forces translate to cover glass 48 and display panel 50 through chassis structure 60 for a synchronous response. Display panel 50 and a backlight 70 couple to a tongue extending from chassis structure 60 at its inner circumference. Cover glass 48 rests on a support surface 62 of chassis structure 60 that defines the size of gap 68 between the inner surface of cover glass 48 and the upper surface of display panel 50. In the example embodiment, gap 68 is a fraction of a millimeter between cover glass 48 lower surface and display panel 50 upper surface. For instance, in one example embodiment a gap is formed of just 0.4 mm for a 75 inch and 86 inch display, although other embodiments may have varied gap sizes. Conventional large touch display assemblies tend to have a gap 68 of at least 4 mm so that reflections associated with Newton Ring effects do not interfere with visual images. In various alternative embodiments, gap 68 may have various sizes based upon the display area and cover glass thickness. For instance, gap 68 may be defined as a fractional value of the cover glass thickness, as less than one-half or less than one-quarter the cover glass thickness, as less than one millimeter, and/or as a fraction of 1 mm, such as the 0.4 mm gap depicted in the example embodiment.

By affixing cover glass 48 and display panel 50 to chassis structure 60 for synchronous motion and reduced spherical relationships, Newton Ring effects are suppressed. Further, an anti-haze treatment is applied to the inner surface of cover glass 48 that further suppresses reflections associated with Newton Ring effects. The anti-haze treatment can induce scratching at display panel 50 if it contacts cover glass 48, so the synchronized motion provides less risk of scratching when anti-haze treatment is used for a given gap 68 size. An examples of an anti-haze treatment that will work in small gap 68 sizes includes NuShield AG film.

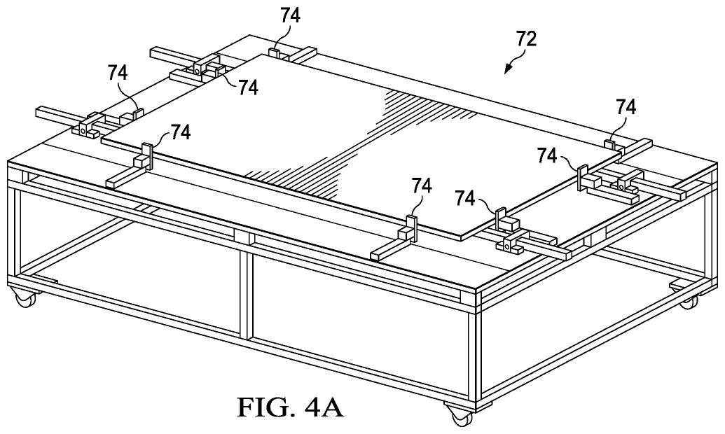

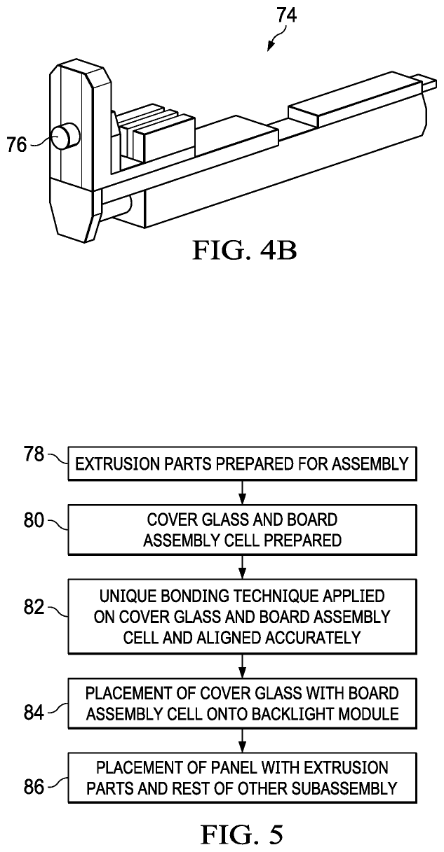

Referring now to FIGS. 4A-4B, a side perspective table depicts a jig table 72 that aligns a board assembly cell and cover glass for assembly. Jig table 72 has plural jig devices 74 disposed around an outer circumference. Each jig device 74 adjusts to align to a cover glass position or a board assembly cell position so that a cover glass and open cell will align relative to each other in a desired position that will fit in the display main chassis of the unibody structure and extruded encasement. Each jig device 74 includes an extension tip 76 that selectively extends and retracts, such as during the bonding process that couples the board assembly cell and cover glass.

Referring now to FIG. 5, a flow diagram depicts a process for assembly of a display having a unibody structure. The process starts at step 78 with preparation of the extrusion encasement parts and, in one embodiment, an extrusion chassis structure. At step 80, a cover glass and board assembly cell/open cell are prepared for assembly. The board assembly cell/open cell includes a display panel coupled to an inner circumference of a unibody support. At step 82, a unique bonding technique is applied to couple the cover glass and board assembly cell/open cell at the chassis structure support surface with an accurate alignment so that the unibody structure will assemble into the display main housing. At step 84, the cover glass and board assembly cell/open cell affixed assembly is coupled to a backlight module to complete display assembly, and at step 86 the display assembly is encased in an extruded encasement for completion of the remaining subassembly.

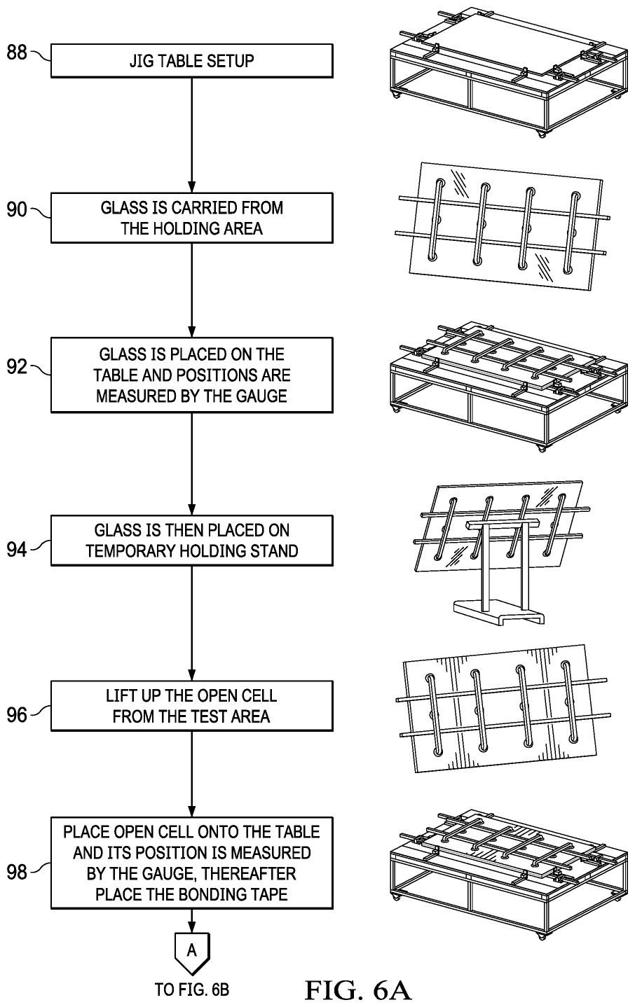

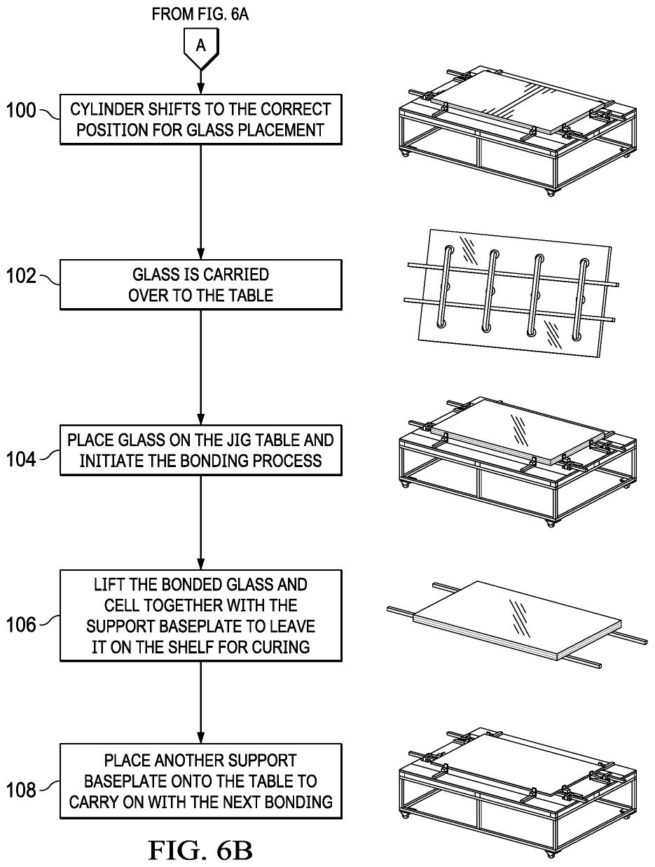

Referring now to FIGS. 6A-6B, a flow diagram depicts a process for aligning the board assembly cell/open cell and cover glass. The process starts at step 88 with a jig table setup having a support baseplate configured to support an open cell assembly and a cover glass. The process continues to step 90 by carrying the cover glass from a holding area to the jig table for placement at step 92 of the cover glass on the jig table at a cover glass position. Alignment of the cover glass is done by abutting the cover glass top and left side against jigs located on the circumference of the jig table with the extension tip retracted. Once the cover glass is in position, the jig devices are moved away, such as with a stepper motor that precisely measures incremental distances, the extension tips are extended, then the jig devices are moved back towards the cover glass on all sides until the extension tips come into contact with the cover glass so that the precise outline of the cover glass is measured. At step 94, the cover glass is removed from the jig table and placed on a temporary stand and at step 96 an open cell is taken from storage to the jig table.

At step 98, the board assembly cell/open cell is placed on the jig table and is aligned to an open cell position, meaning the position relative to the cover glass so that the support surface of the chassis structure in the open cell aligns with a desired location of the cover glass. Alignment of the open cell on the jig table follows a similar process to the cover glass with a pair of sides pressed against the jig devices to establish the open cell position followed by precise measurement of the open cell with stepper motor movement of the jig devices until extension tips press against each side of the open cell. At step 98, an adhesive tape is place on the open cell support surface to prepare for placement of the cover glass. Other types of adhesives may be used, however, an adhesive tape that is not activated allows movement of the cover glass across the tape without marking the cover glass. Once the position of the open cell is determined by the jig devices, the process continues to step 100 by shifting the jig device to positions determined for alignment of the cover glass. For example, the top and left sides of the jig device are put in a final position based upon a distance of the cover glass edge to the open cell edge, while a small space is allowed on the right and lower sides to provide room to fit the cover glass within the jig devices. At step 102 the cover glass is brought from storage and, at step 104 placed upon the jig table in the cover glass position. Once the cover glass is in position, bonding is accomplished by activation of the adhesive tape, such as with heat or infrared light. After adhesive activation is complete, the process continues to step 106 to lift the bonded cover glass and open cell together with the support baseplate for placement in storage to complete curing of the adhesive. At step 108, the jig table is prepared for assembly of another display by placing another support baseplate on the jig table.

Although the present invention has been described in detail, it should be understood that various changes, substitutions and alterations can be made hereto without departing from the spirit and scope of the invention as defined by the appended claims.

What is claimed is:

1. An information handling system comprising:
a housing;
a processor disposed in the housing and operable to execute instructions that generate information;
a memory interfaced with the processor and operable to store the instructions and information;
a graphics controller interfaced with the processor and memory to process the information into pixel values that define a visual image for presentation at a display;
a communication device interfaced with the graphics controller and operable to communicate the pixel values to the display; and
a peripheral display operable to accept the pixel values for presentation as visual images at a display panel, the peripheral display having a chassis structure coupling a cover glass and a display panel to a shared support structure that maintains a gap between the cover glass and the display panel.

2. The information handling system of claim 1 further comprising:
an adhesive tape disposed between a support surface of the chassis structure and the cover glass, the adhesive tape curing to couple the cover glass to the support surface;
wherein the support surface defines a cavity within an inner circumference of the chassis structure, the display panel disposed in the cavity to have the gap defined between the display panel surface and support surface.

3. The information handling system of claim 2 wherein the display panel comprises a liquid crystal display panel, the information handling system further comprising a backlight coupled to the chassis structure in the cavity under the display panel.

4. The information handling system of claim 2 further comprising an anti-haze treatment disposed on the cover glass at a side adjacent the display panel.

5. The information handling system of claim 4 wherein the gap has a distance between the cover glass and the display panel that is a fraction of the thickness of the cover glass.

6. The information handling system of claim 5 wherein the chassis structure couples the cover glass and the display panel to the shared support structure to promote synchronous motion of the cover glass and display panel in response to vibration.

7. The information handling system of claim 6 further comprising capacitive touch detection integrated in the display panel.

8. The information handling system of claim 2 wherein the cover glass and the display panel couple to the chassis structure by a method comprising:
first disposing the cover glass on a jig to determine a desired relative position of the cover glass;
second removing the cover glass from the jig;
third disposing the chassis structure on the jig with the display panel coupled in the cavity to determine a desired relative position of the chassis structure;
fourth disposing the adhesive tape to the chassis structure support surface;
fifth adjusting the jig to accept the cover glass at the determined position; and
sixth disposing the cover glass on the chassis structure to contact the adhesive tape guided by the jig to the determined position.

9. A method for manufacture of a display, the method comprising:
disposing a cover glass on a jig to determine the cover glass position on the jig relative to a final assembly position;
removing the cover glass from the jig;
integrating a display panel in an interior circumference of a chassis structure having a support surface with a gap defined between the display panel and support surface;
disposing the chassis structure on the jig to determine the chassis structure position on the jig relative to the final assembly position;
applying adhesive to the support surface; and
disposing the cover glass on the jig over the chassis structure at the cover glass position.

10. The method of claim 9 further comprising:
applying as the adhesive an adhesive activated by a curing process; and
curing the adhesive tape with the cover glass disposed on the display panel in the jig.

11. The method of claim 10 wherein the adhesive comprises an adhesive tape.

12. The method of claim 10 further comprising:
defining a gap between the display panel and the cover glass with the chassis structure; and
maintaining the gap by the coupling of the display panel and the cover glass to the chassis structure.

13. The method of claim 12 further comprising:
vibrating the chassis structure; and
suppressing presentation of Newton Rings during the vibrating by synchronized motion of the display panel relative to the cover glass.

14. The method of claim 12 wherein the gap comprises a distance of less than a thickness of the cover glass.

15. The method of claim 14 further comprising:
treating the cover glass with an anti-haze treatment at the side of the cover glass proximate to the display panel; and
maintaining the gap sufficiently to prevent contact of the anti-haze treatment and the display panel.

16. The method of claim 9 further comprising:
coupling a backlight to the chassis structure opposite the cover glass; and
encasing the chassis structure with an extruded housing.

17. A display comprising:
a chassis structure defining an inner circumference and a support surface outside the inner circumference;
a display panel having plural pixels operable to present a visual image, the display panel coupled to the chassis structure at the inner circumference; and
a cover glass coupled to the chassis structure support surface by an adhesive, the cover glass having a predetermined gap distance from the display panel.

18. The display of claim 17 wherein the gap distance is less than half of the thickness of the cover glass.

19. The display of claim 17 wherein the adhesive comprises an adhesive tape activated after contact between the cover glass and chassis structure.

20. The display of claim 19 further comprising an extruded cover encasing the chassis structure after activation of the adhesive tape.
